(19) United States
(12) Patent Application Publication
(10) Pub. No.: US 2020/0151835 A1
(43) Pub. Date: May 14, 2020

(54) User Driven Feedback Mechanism for Personalized Recipe Changes for Beverages

(71) Applicant: PicoBrew, Inc., Seattle, WA (US)

(72) Inventor: William H. Mitchell, Medina, WA (US)

(73) Assignee: PicoBrew, Inc., Seattle, WA (US)

(21) Appl. No.: 16/190,197

(22) Filed: Nov. 14, 2018

(51) Int. Cl. G06Q 50/12; G06Q 30/06; G06F 3/0482

(52) U.S. Cl. CPC G06Q 50/12; G06F 3/0482; G06Q 30/0621; G06Q 30/0641

(57) ABSTRACT

An automated or semi-automated beverage brewing machine may be programmed using individualized recipes that may be modified and stored based on user input. A user may receive a query or provide input regarding a beverage they may have consumed, and their input may cause the recipe for their beverage to be updated or changed. The updated recipe may be stored for use the next time the user may request the beverage. In some cases, a cell phone app may be used to select and modify a beverage recipe, as well as to collect the user's input after drinking the beverage. In other cases, an automated or semi-automated brewing machine may have an interface through which a user may select beverages and, in some cases, provide input regarding the beverage. A user's preferred recipe may be transferred to different beverage brewing devices whenever the user may request the beverage.

### BACKGROUND

Consumers enjoy personalization, including personalizing their drinks at a coffee house or when they brew drinks at home. Some consumers like strong coffee, while other consumers may enjoy weaker coffee, for example. As consumers become more aware of their likes and dislikes, they become more engaged and enlightened consumers.

Retailers and other beverage providers who can accommodate their customer's likes and dislikes may gain customer loyalty and therefore revenue.

### SUMMARY

An automated or semi-automated beverage brewing machine may be programmed using individualized recipes that may be modified and stored based on user input. A user may receive a query or provide input regarding a beverage they may have consumed, and their input may cause the recipe for their beverage to be updated or changed. The updated recipe may be stored for use the next time the user may request the beverage. In some cases, a cell phone app may be used to select and modify a beverage recipe, as well as to collect the user's input after drinking the beverage. In other cases, an automated or semi-automated brewing machine may have an interface through which a user may select beverages and, in some cases, provide input regarding the beverage. A user's preferred recipe may be transferred to different beverage brewing devices whenever the user may request the beverage.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing recipe management systems for beverage machines.

FIG. 2 is a diagram illustration of an embodiment showing a schematic or functional representation of a network with recipe management for beverage machines.

FIG. 3 is a flowchart illustration of an embodiment showing a method for delivering a beverage and collecting feedback.

FIG. 4 is a flowchart illustration of an embodiment showing a method for making private recipes public.

### DETAILED DESCRIPTION

User Driven Feedback Mechanism for Personalized Recipe Changes for Beverages

An automated or semi-automated beverage brewing system may produce a beverage for a consumer, and the consumer may be queried about different characteristics about the beverage. The consumer's input may cause the recipe for their beverage to be updated and stored, so that the next time the consumer requests the beverage, their tastes and preferences may be automatically incorporated.

A user interface may allow a consumer (referred to herein as a “user”) to select a beverage. The user interface may allow a user to have a beverage produced using a standard recipe, or may allow the user to modify the beverage to meet their personal preferences.

Once the beverage is selected, a recipe for the beverage may be downloaded to a beverage device, where the beverage may be produced. In some cases, the recipe may be stored at the device which may produce the beverage, while in other cases, the recipe may be stored remotely.

After producing the beverage, another user interface may be provided to the consumer. This user interface may query the user to determine if there may be any changes to the recipe for next time the beverage may be produced. The queries may ask questions to determine if the temperature of the beverage was too hot or too cold, or if the beverage was too sweet or too bitter. The queries may be designed to elicit changes to a recipe for the beverage, then the updated recipe may be stored for future use.

Some systems may allow a user to create a recipe for the first time the user may request a beverage. For example, a user may create their own fountain drink by selecting a mixture of soft drink flavors. The user may enter the mixture at a drink dispenser, then the user may associate the mixture with their user identifier. The user may receive a query asking if the user would like to make changes to their customized soft drink, and the updated recipe may be stored for later use.

In another use case, an automated or semi-automated beverage machine may produce coffee or other hot drinks. The beverage machine may receive a recipe for a specific drink for a customer, and may make the drink according to the customer's wishes, with the specific temperature, bitterness, strength, and other parameters exactly like they requested. The recipe may be developed by getting feedback after the customer had previous drinks, with the different parameters being tuned or adjusted with each query and input.

A system may collect and manage users' beverage preferences. A user may be able to create, manage, and store recipes from previous beverages in a personal profile. In some cases, a user may be able to create a recipe through a user interface on a beverage production machine, then store the recipe to their personal profile. A user may be able to make adjustments to each recipe, either through direct changes to ingredient lists and processing parameters, or through questionnaires, queries, or other input from which changes to a recipe may be made.

A user's personal list of recipes may be presented to a user, then a selected recipe may be transferred to a beverage machine when a user requests a beverage. For example, a user may store several recipes for favorite coffee drinks that the user may purchase from a coffee chain. Upon entering a store or placing an order, the user may select a specific recipe, which may be transferred to the retail store. The recipe may be transferred to an automated or semi-automated machine from which the beverage may be produced.

The recipes may be defined in a high level definition which may or may not be readily executed by a beverage machine. In many cases, beverage machines may have different capabilities and different capacities. For example, one machine may have a different temperature range capability than another machine. In such an example, a consumer-level device at a consumer's home may be able to heat and dispense liquid at a certain temperature and volume, while a commercial-level device found in a restaurant may be capable of a greater range of temperature and volume.

Even though a recipe may be executed on different devices, the resulting beverage may be nearly identical in many cases. Each device may have an interpreter or virtual machine that may convert recipes into commands that may control the specific machine. For example, one machine may have a steam injection heat system, which may operate by first heating up a steam generator then introducing a predefined amount of water to generate a specific temperature increase. Another machine may have a recirculating heating system, which may recirculate liquid through a heater until a temperature has been achieved. Each device may have a different set of specific commands to execute to generate a specific volume of liquid at a specific temperature, yet both devices may execute the same recipe.

A community of users may share and distribute their recipes. For a specific beverage, a manufacturer may define a baseline or starting recipe, but users may update, change, and improve the recipe. The changed recipes may be made available through an online community to be shared with other users.

In many devices, a consumable package may be created for specific beverages. For example, a coffee-based drink may have specific types of coffee beans with a specific grind and with various adjuncts or flavors. The consumable manufacturer may define a recommended recipe that may be available through an online community. Over time, the recommended recipe may be updated, modified, and saved as alternative recipes for the consumable product.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

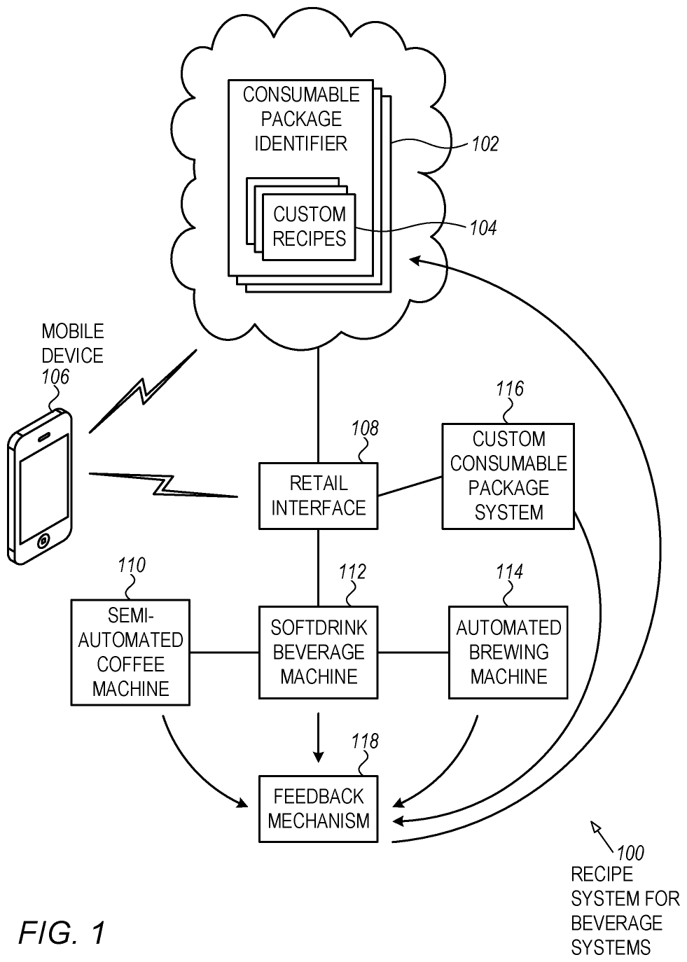

FIG. 1 is a diagram illustration of an example embodiment 100 showing a recipe system for beverage machines. Embodiment 100 illustrates how a consumable package 102 may have customized recipes 104 associated with the package, and how the consumable package and the customized recipe may be used with different types of beverage machines.

In the example of embodiment 100, a consumable package 102 may be an ingredient kit for a beverage machine. In an example of a coffee brewing machine, a consumable package may include ground coffee, flavorings, sweeteners, adjuncts, or other items.

In some cases, such a consumable package may have different compartments for the ingredients, and a brewing machine may have a capability of adjusting how much of each ingredient may be consumed for a beverage. In one such type of system, the ingredients may be dry ingredients that may processed by passing water through the ingredients. By varying the time and temperature of the water, different amounts of extractions may be performed.

The flexibility and programmability of such machines may be managed by having customized recipes for each consumable package. A user may provide feedback about their beverage, and their recipe may be updated and saved for future use.

A user may interact with the various systems using a mobile device 106. On the mobile device, a user may select a beverage, which may coincide with the selection of a beverage consumable package 102. The user may be presented with several recipe options, including a default recipe suggested by a manufacturer, customized recipes from other users, and the user's previous recipes.

The user may select a beverage and recipe, which may be passed to a retail interface 108. The retail interface 108 may be a website, application, or other service through which a user may purchase a beverage. In one such example, a user may select a retail location for purchasing a beverage, determine which beverage to purchase, and send a recipe to the location for execution. The recipe may be passed directly to the machine that may manufacture the beverage.

Examples of automated beverage machines may include automated or semi-automated coffee machines 110, a soft drink beverage machine 112, or some other automated brewing machine 114. An automated or semi-automated coffee brewing machine 110 may make espresso drinks, brewed coffee, or other types of coffee drinks. In the case of a semi-automated machine, a human operator may prepare some of the beverage. In a fully automated machine, much of the beverage preparation may be performed without human interaction.

A coffee machine 110 may have different capabilities and programmable parameters. Some machines may have the ability to adjust the temperature and quantity of water used for processing coffee, such as adjusting the steep time of brewed coffee or adjusting the strength of an espresso shot. Some machines may allow for coffee grind adjustments, such as making the grind fine or coarse. In some cases, a pre-manufactured consumable package may have pre-ground coffee, where the adjustable parameters may be the time, temperature, and sometimes pressure of the contact between water and coffee.

The differences between different types of coffee machines may highlight a characteristic of the recipe system. That is, the recipe may be defined in a manner that may be interpreted by different beverage machines based on the machine's individual characteristics. For example, a recipe with a specific desired outcome may be performed in different manners for different machines. A stronger cup of coffee may be performed by using a finer grind on a machine that grinds coffee at the time of brewing, while a machine that uses consumable packages of pre-ground coffee may use a longer contact time to achieve the same beverage.

The differences between machines may be achieved by having a software layer that translates between recipe components and machine-level commands that may be executed by the hardware.

A soft drink beverage machine 112 may be another example of a beverage machine that may execute a recipe. Many soft drink beverage machines may have a wide selection of syrups, adjuncts, sweeteners, and other components, and a recipe may call for specific amounts of the various ingredients.

In one example, a user may place an order at a fast food restaurant, which may include food and a beverage. The beverage order may include a recipe for a soft drink that may include, for example, a base beverage and shots of flavor, such as a shot of cherry and a shot of lemon. The beverage order may be placed with the restaurant's ordering system, and the recipe for the customer's beverage may be transmitted to the beverage machine for preparation.

An automated brewing machine 114 may be any type of machine that may manufacture a beverage, such as a tea, chai, energy drink, nutraceutical beverage, or any other drink. In many cases, the automated brewing machine 114 may manufacture beverages to order. In other cases, an automated brewing machine 114 may manufacture fermented beverages, where the beverage may take several days or even weeks to complete. An automated brewing machine 114 may have many different parameters that may be adjusted to a customer's preferences.

Some systems may have a custom consumable package system 116, which may produce consumable beverage packages that may incorporate a user's specific adjustments to a recipe. For example, a consumer may use an off-the-shelf beverage package for a beverage, but may adjust the beverage to emphasize various elements, such as making the base beverage stronger while reducing an adjunct flavor. Based on the consumer's preferences, a consumable package may be manufactured that incorporates the adjustments to the base recipe. In the example, a customized package may include additional base ingredient and less adjunct. Such an adjustment may allow the consumer to enjoy a beverage to their preferences while operating the beverage machine within its normal operating range.

A feedback mechanism 118 may interact with a consumer and determine whether any changes may be made to the consumer's recipe for their beverage. The feedback mechanism 118 may include a set of interactive user interfaces through which a user may rate their beverage and suggest changes to the beverage for future use.

One example of such a feedback mechanism 118 may present several variables for a user to adjust with their recipe. In an example of a coffee beverage, the user interface may include slider bars or other input mechanisms, where the user may adjust strength, bitterness, sweetness, temperature, adjuncts, other ingredients, or any other parameter. From the user's input, adjustments may be made to their current recipe, then the updated recipe may be added to the custom recipes 104.

The feedback mechanism 118 may serve to capture a consumer's taste preferences, allowing the consumer to customize their beverage to their liking. An additional use of such information may be to identify new beverages that meet customer's tastes. By analyzing the recipe customizations for many different users, regional, social, or other demographically-related trends and preferences may be identified. Such trends may allow a beverage provider to tailor their products to best serve their customers.

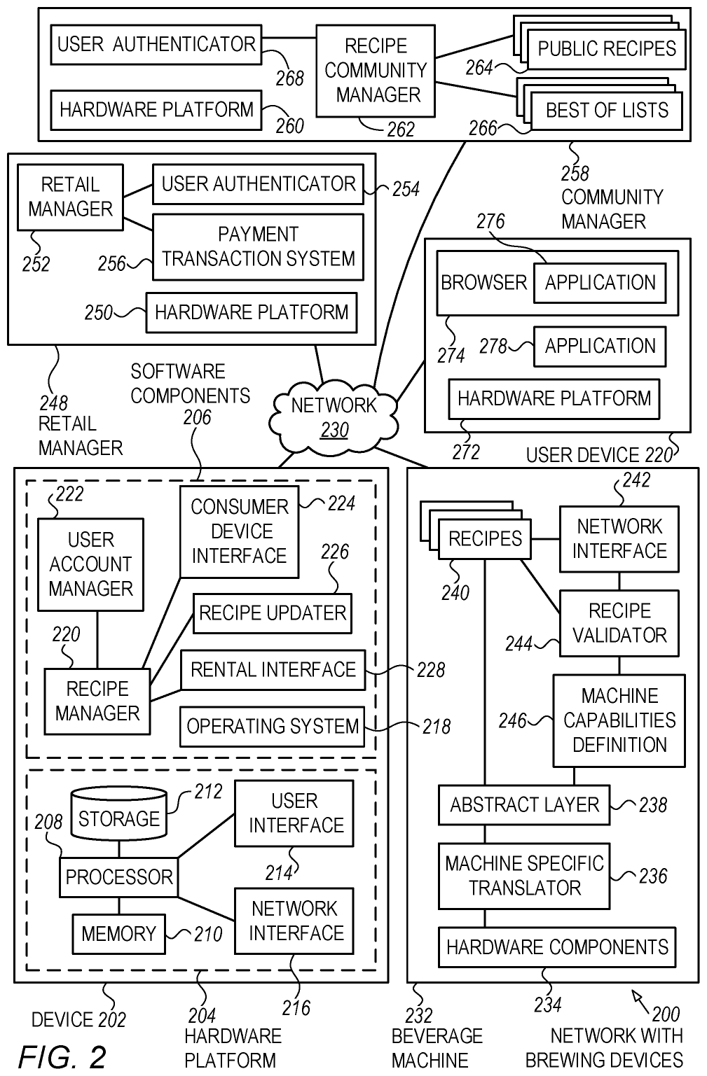

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a device 202 that may have a hardware platform 204 and various software components. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device. In some embodiments, the device 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

A recipe manager 220 may be a central application through which a user may add, modify, delete, and perform various functions with their recipes. In many cases, a recipe manager 220 may operate with a user account manager 222, where a user may be able to create and manage their account. The recipe manager 220 may allow a user to have their own private area for managing their recipes, and may be a portal or interface for a recipe community, where users may share, rank, comment on, and interact with other user's recipes.

A consumer device interface 224 may be a connection to a consumer-level device that may produce beverages. A consumer-level device may be located in a consumer's home and may manage a set of recipes for the people in a household. In some cases, such a system may be able to associate recipes for individual people in the household by name, while in other cases, such a system may have a set of customized recipes that may not be associated with specific people.

A recipe updater 226 may be a mechanism by which information may be collected from a user to make adjustments to their recipes. The recipe updater 226 may communicate with a user after a beverage has been prepared. In some cases, the recipe updater 226 may push notifications to the user, such as sending a text message, email message, or some other communication. In other cases, the recipe updater 226 may be a passive application where a user may initiate the interaction.

The recipe updater 226 may have various user interface mechanisms where a user's feedback may then be used to update a recipe. In some embodiments, the recipe updater 226 may have a question and answer format, while in other embodiments, a set of user interface controls may be presented. In still other embodiments, the user may be able to edit a recipe definition with a text editor or some other interface.

A question and answer format for a recipe updater 226 may have a series of questions that a user may answer regarding their beverage. For example, a question may ask if the user thought the beverage was too bitter or the flavors too intense. If the user responds with yes, the recipe may be adjusted to reduce the bitterness or flavors in the next version of the beverage.

A user interface controls version of a recipe updater 226 may have a series of sliders, dials, numeric adjustments, or other user interface controls where a user may be able to adjust various parameters for their beverage. A bitterness slider may have a knob that can be slid left or right or up and down to adjust the bitterness of the next beverage with respect to the beverage the user just consumed.

A retail interface 228 may interact with a retail management system to purchase beverages from a retail establishment. In many cases, the recipe manager 220 may keep a set of recipes and preferences for specific retail chains or individual shops.

When a user interacts with a retail system through the recipe manager 220, the retail interface 228 may retrieve the capabilities of beverage machines in the retail establishment and may surface those capabilities to the user. For example, a user may determine that they want to visit a local coffee shop which may have an automated brewing machine. The retail interface 228 may determine which beverages may be available at the location, and make those beverages and their associated recipes available to the user for selection. After selecting a beverage and possibly modifying the recipe, the retail interface 228 may facilitate the monetary transaction and transfer the recipe to the establishment.

The device 202 may be connected to other devices through a network 230. In the example of embodiment 200, the device 202 is illustrated as being separate from some of the other devices. However, other embodiments may incorporate some or all of the features or functionality of the device 202 and vise versa.

A beverage machine 232 may have a set of hardware components 234 for producing a beverage. The components may include pumps, valves, heaters, chillers, carbonation, level indicators, and other sensors that may make up the machine's beverage production system.

A machine specific translator 236 may be a virtual machine or other software component that works with an abstraction layer 238 to process recipes 240. In many cases, a single recipe 240 may be produced by many different machines, each of which may have a separate set of hardware components 234. Each of the machines may operate on different principles, yet the machine specific translator 236 and abstraction layer 238 may convert the standard recipe 240 to produce the same beverage.

The machine specific translator 236 and abstraction layer 238 may allow a common recipe language to be universal across beverage machines with different capabilities and even across beverage machines from different manufacturers.

A machine capabilities definition 246 may contain the adjustable parameters and capabilities of the machine 232, and may operate with a recipe validator 244 to determine whether the machine 232 may be able to produce the recipe. In some cases, a recipe validator 244 may analyze a recipe and determine that one or more parameters may not be able to be met by the machine. In such a case, those differences may be surfaced to the consumer, who may elect to have the beverage made with the available capabilities.

A network interface 242 may be a connection through which the machine capabilities may be transmitted to a user, as well as through which the beverage machine 232 may receive recipes.

A retail manager 248 may be a system that may facilitate retail sales of beverages. The retail manager 248 may operate on a hardware platform 250, and may have a retail manager 252 that may interface with a user authenticator 254 and a payment transaction system 256.

The retail manager 252 may be a website, application, or other component that may handle retail transactions. A user may access the retail manager 252, identify a retail establishment from which to purchase a beverage, and complete a transaction. The retail manager 252 may interface with a retailer's point of sale system, accounting system, or other software platforms.

The user authenticator 254 may establish a user's identity within the retail environment, such as establishing an account, determining payment methods, storing and retrieving receipts, and other administrative functions. The payment transaction system 256 may establish a transaction between the user and the retailer, and perform payment transfer to the retailer.

A community manager 258 may be a platform on which users may share recipes and perform other functions. The community manager 258 may operate on a hardware platform 260, and may have a recipe community manager 262 application. The recipe community manager 262 may have a repository of public recipes 264 as well as some best of lists 266. The recipe community manager 262 may have a user authenticator 268.

The user authenticator 268 may be a mechanism for users to establish accounts, create user profiles, and other administrative functions.

The recipe community manager 262 may receive recipes for public use and make those recipes available in a repository of public recipes 264. In many cases, a user may create their own recipe or modify an existing recipe, then may share their recipe with others through the repository of public recipes 264. Users may comment, share, or use those recipes, and those recipes that gain popularity may be listed in various best of lists 266.

A user device 270 may have a hardware platform 272, on which a browser 274 may execute an application 276, or where a native application 278 may execute. The user device 270 may be a mobile telephone, tablet computer, desktop computer, or some other device. The applications 276 or 278 may interface with the retail manager 252, the recipe manager 220, or the recipe community manager 262 to allow the user to select a beverage, modify a recipe, store their recipes, cause a beverage to be purchased, share recipes, and many other functions.

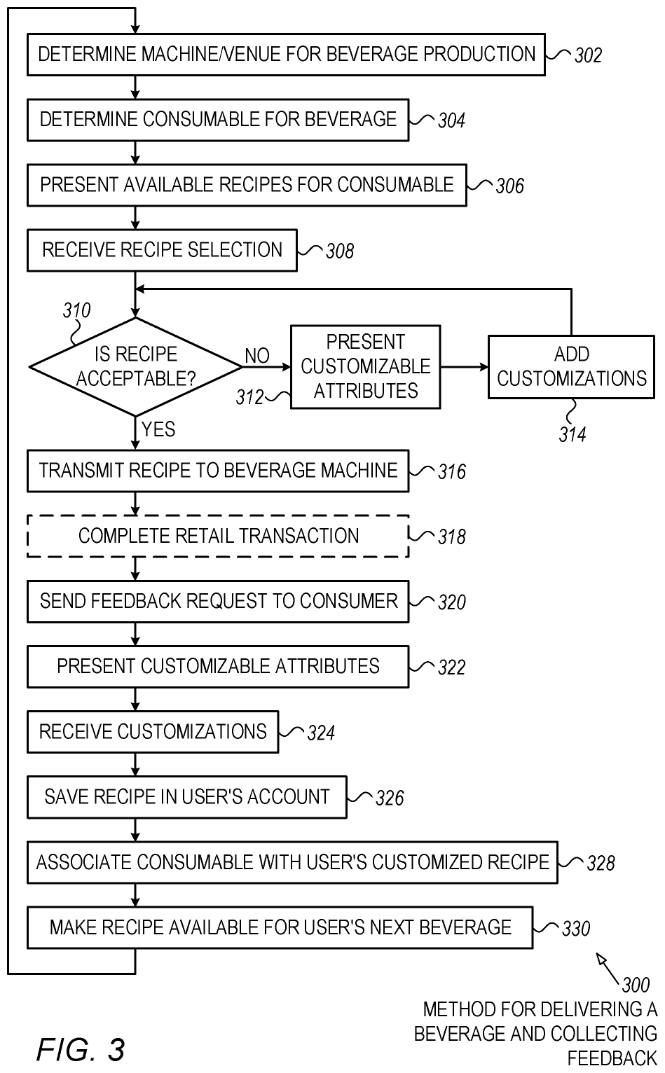

FIG. 3 is a flowchart illustration of an embodiment 300 showing a method for delivering a beverage and collecting feedback. Embodiment 300 is merely one example of a sequence that may be performed to by a beverage machine. In some cases, the functions of embodiment 300 may be performed by a management system that may operate separately from a beverage machine.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A machine or venue for producing a beverage may be determined in block 302. In a consumer-level situation, a device may be located within a consumer's home and may be the default machine for beverage production. In a retail environment, a consumer may select a restaurant, coffee shop, or other retail location from which to purchase a beverage.

A consumable package may be selected for the beverage in block 304. In many cases, especially for a consumer-level device, a consumable package may contain the ingredients for a specific type of beverage, but the beverage may be modified to suit a user's preferences. In a retail environment, there may or may not be a specific consumable package and a retail-level machine may have bulk materials from which a beverage may be produced.

In both cases, the consumable package or the capabilities of the beverage machine may be used to determine a list of available recipes for the beverage. The list may be presented to the consumer in block 306. In many cases, the list of recipes may include default, baseline, or recommended recipes, as well as recipes created by other consumers or users, and additionally any recipes that the consumer may have created, customized, and stored for future use.

The recipe selection may be received in block 308. If the recipe is not acceptable in block 310, a list of customizable attributes may be presented in block 312, and the user-selected customizations may be added to the recipe in block 314. The process may loop through blocks 310 through 314 until the recipe may be acceptable to the consumer in block 310.

Once the recipe is acceptable in block 310, the recipe may be transmitted to a beverage machine in block 316. If the beverage is being purchased through a retail establishment, the retail transaction may be completed in block 318.

After the beverage may have been produced and consumed, a feedback request may be transmitted to the consumer in block 320. A list of customizable attributes may be presented in block 322, and the customizations may be received in block 324.

A customized recipe based on the consumer's input may be saved in the consumer's account in block 326. The customized recipe may be associated with the consumable in block 328, and the recipe may be made available for the consumer's next beverage in block 330.

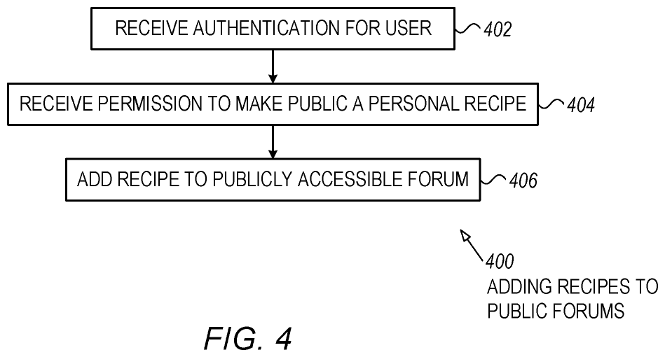

FIG. 4 is a flowchart illustration of an embodiment 400 showing a method for making recipes publically available. Embodiment 400 may be performed by a recipe community manager.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Authentication for a user may be received in block 402, and permission may be received in block 404 to make a specific recipe public. The recipe may be added to a publicly accessible forum in block 406.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
at least one processor;
a method performed by said at least one processor, said method comprising:
causing a first user interface to be presented to a user and receiving a first user input from said first user interface, said first user input defining a first beverage to produce;
causing said first beverage to be produced using a first recipe;
causing a second user interface to be presented to said user and receiving a second user input from said second user interface, said second user input defining a first change to said beverage;
updating said first recipe to create a second recipe, said second recipe comprising said first change to said first beverage; and
receiving a third user input from said first user interface and causing a second beverage to be produced using said second recipe.

2. The system of claim 1, said method being performed on a first device, said first device being a device used to produce said beverage.

3. The system of claim 1, said method being performed on a first device, said first beverage being produced by a second device.

4. The system of claim 3, said method further comprising:
receiving a user identifier identifying a first user; and
storing said second recipe with an association to said first user.

5. The system of claim 4, said second user interface comprising at least one question regarding preferences for said first user with respect to said beverage.

6. The system of claim 5, said preferences comprising at least one of a group composed of:
beverage temperature;
beverage bitterness;
beverage sweetness;
beverage strength;
beverage ingredients; and
beverage adjuncts.

7. The system of claim 3, said second beverage being produced on a third device.

8. The system of claim 7, said second device and said third device having different beverage production capabilities.

9. The system of claim 3, said second device being a soft drink mixing machine.

10. The system of claim 3, said second device being a hot beverage machine.

11. The system of claim 10, said second device being a coffee drink machine.

12. The system of claim 1, said method further comprising:
making said second recipe available to a second user.

13. The system of claim 12, said method further comprising:
receiving an authentication from said user; and
making said second recipe available to a community-accessible online repository.

14. A method performed by a computer processor, said method comprising:
causing a first user interface to be presented to a user and receiving a first user input from said first user interface, said first user input defining a first beverage to produce;
causing said first beverage to be produced using a first recipe;
causing a second user interface to be presented to said user and receiving a second user input from said second user interface, said second user input defining a first change to said beverage;
updating said first recipe to create a second recipe, said second recipe comprising said first change to said first beverage; and
receiving a third user input from said first user interface and causing a second beverage to be produced using said second recipe.

15. The method of claim 14, said method being performed on a first device, said first device being a device used to produce said beverage.

16. The method of claim 14, said method being performed on a first device, said first beverage being produced by a second device.

17. The method of claim 16, said method further comprising:
receiving a user identifier identifying a first user; and
storing said second recipe with an association to said first user.

18. The method of claim 17, said second user interface comprising at least one question regarding preferences for said first user with respect to said beverage.

19. The method of claim 18, said preferences comprising at least one of a group composed of:
beverage temperature;
beverage bitterness;
beverage sweetness;
beverage strength;
beverage ingredients; and
beverage adjuncts.

20. The method of claim 16, said second beverage being produced on a third device.
